(19) United States
(12) Patent Application Publication
(10) Pub. No.: US 2009/0010482 A1
(43) Pub. Date: Jan. 8, 2009

(54) Diagrammatizing Apparatus

(75) Inventors: Makoto Nishida, Toyota-shi (JP); Akihiro Watanabe, Nagoya-shi (JP)

Correspondence Address: OLIFF & BERRIDGE, PLC, P.O. BOX 320850, ALEXANDRIA, VA, 22320-4850, US

(73) Assignees: Toyota Jidosha Kabushiki Kaisha, Toyota-shi (JP); Kabushiki Kaisha Toyota Chuo Kenkyusho, Aichi-gun (JP)

(21) Appl. No.: 11/597,888

(22) PCT Filed: May 25, 2005
(86) PCT No.: PCT/JP05/10005

§ 371 Date: Mar. 6, 2007

(30) Foreign Application Priority Data
Jun. 2, 2004 (JP) 2004-164942

(51) Int. Cl. G06K 9/00

(52) U.S. Cl. 382/100

(57) ABSTRACT

A diagrammatizing apparatus (20) for vehicle lane detection which detects at least two lines of boundary lines of the sign lines (5L, 5R) or the boundary lines of a vehicle lane (4) on the road surface from a picked-up image of the road surface, includes a first boundary line extracting unit that selects a longest line (L₀) as a first boundary line from a first line group consisting of plurality of lines (L₀), La, Lb which intersect with each other in the image, and a second boundary line extracting unit that selects a longest line (L₁₀) as a second boundary line from a second line group consisting of a plurality of lines (L₁₀, Lc, Ld) which intersect with each other in the image.

### TECHNICAL FIELD

The present invention relates to a diagrammatizing apparatus, and more particularly to a diagrammatizing apparatus for vehicle lane detection.

### BACKGROUND ART

A conventionally known diagrammatizing apparatus for vehicle lane detection detects a boundary line of a sign line or a lane drawn on a road surface on which a vehicle runs. The boundary lines of the sign lines or the lanes detected by the diagrammatizing apparatus are employed by a driving support system which performs lane keeping operation for the vehicle based on the boundary line of the sign lines or the lanes, or by a deviation warning system which detects lateral movements of the vehicle based on the boundary lines of the sign lines or the lanes and raises alarm if the vehicle is determined to be likely to deviate from the lane as a result of detection. Here, the sign line includes a boundary position of a lane such as a line separating each lane and a compartment line such as a white line or a yellow line, and a vehicle guiding dotted line provided to call attention of vehicle occupants.

Such a conventional diagrammatizing apparatus is disclosed, for example, in Japanese Patent Laid-Open Nos. H8-320997 and 2001-14595.

A conventional diagrammatizing apparatus for vehicle lane detection extracts luminance data associated with each pixel position from an image picked up by a camera, extracts pixel positions with higher luminance than a threshold as edge points from the extracted luminance data, and detects an edge line (straight line as a candidate boundary line of the sign line or the lane from the extracted edge points using a diagrammatizing technique such as Hough transform.

When a first line and a second line which do not intersect with each other and have a maximum length in an image, for example, an image of the boundary lines of the sign lines or the lane drawn on a road surface on which a vehicle runs, suppression of the extraction of lines other than the first line and the second line is desirable.

When the conventional diagrammatizing apparatus for vehicle lane detection process an image to extract points, the points tend to contain noises, and often represent images other than the boundary lines of the sign lines or the lane for the vehicle (shadow of the vehicle or the curbs, for example). Hence, lines other than the candidate boundary lines of the sign lines or the lanes, which are original target of the extraction, are extracted as a result of the line extraction from the points by the diagrammatizing technique, whereby the processing cost increases. Thus, such technique is disadvantageous for the detection of boundary lines of sign lines or lanes for the vehicle.

### DISCLOSURE OF INVENTION

In view of the foregoing, an object of the present invention is to provide a diagrammatizing apparatus capable of extracting a first line and a second line which do not intersect with each other and have a maximum length in an image from the image while suppressing extraction of lines other than the first line and the second line.

Another object of the present invention is to provide a diagrammatizing apparatus for vehicle lane detection capable of extracting the boundary line of the sign line or the lane while suppressing the extraction of lines other than the boundary line of the sign line or the lane, at the time of extraction of the boundary line of the sign line or the lane drawn on a road surface on which the vehicle runs from an image of the road surface.

A diagrammatizing apparatus according to the present invention which extracts a first line and a second line which do not intersect with each other and have maximum length from an image, includes: a first line extracting unit that selects a longest line as the first line from a first line group consisting of a plurality of lines which intersect with each other in the image; and a second line extracting unit that selects a longest line as the second line from a second line group consisting of a plurality of lines which intersect with each other in the image.

A diagrammatizing apparatus for vehicle lane detection according to the present invention which detects at least two lines of boundary lines of sign lines or boundary lines of a vehicle lane on a road surface from an image of the road surface, includes: a first boundary line extracting unit that selects a longest line as the first boundary line from a fist line group consisting of a plurality of lines which intersect with each other in the image; and a second boundary line extracting unit that selects a longest line as the second boundary line from a second line group consisting of a plurality of lines which intersect with each other in the image.

In the diagrammatizing apparatus according to the present invention, the line is formed with a line of points, and the length of the line is found based on a distance between two points which located farthest from each other among a plurality of points which constitute the line of points of the line.

In the diagrammatizing apparatus according to the present invention, the line is formed with a line of points, and the length of the line is found based on a number of points which constitute the line of points of the line.

In the diagrammatizing apparatus according to the present invention, the line is formed with a line of points, and the length of the line is found based on a function of a distance between two points which located farthest from each other among a plurality of points which constitute the line of points of the line and a number of points which constitute the line of points of the line.

In the diagrammatizing apparatus according to the present invention, the line which is formed with the line of points is extracted from the points in the image via Hough transform.

In the diagrammatizing apparatus according to the present invention, each of the first line group and the second line group is detected as a result of determination on whether the plurality of lines intersect with each other or not with a use of a parameter space of the Hough transform.

In the diagrammatizing apparatus according to the present invention, selection of the longest line from the first line group and selection of the longest line from the second line group are performed with at least one of a vote value cast in the parameter space of the Hough transform, and a coordinate value corresponding to points to which a vote is cast in the parameter space.

According to the present invention, the first line and the second line which do not intersect with each other and have a maximum length in an image can be extracted from the image while extraction of lines other than the first line and the second line is suppressed.

### BRIEF DESCRIPTION OF DRAWINGS

FIG. 1A is a flowchart of a part of an operation by a diagrammatizing apparatus for vehicle lane detection according to an embodiment of the present invention;

FIG. 1B is a flowchart of another part of the operation by the diagrammatizing apparatus for vehicle lane detection according to the embodiment of the present invention;

FIG. 2 is a flowchart of still another part of the operation by the diagrammatizing apparatus for vehicle lane detection according to the embodiment of the present invention;

FIG. 3 is a flowchart of still another part of the operation by the diagrammatizing apparatus for vehicle lane detection according to the embodiment of the present invention;

FIG. 4 is a schematic diagram of edge points which are geometrically converted and arranged in separate upper and lower areas by the diagrammatizing apparatus for vehicle lane detection according to the embodiment of the present invention;

FIG. 5A is a diagram of xy space shown to describe Hough transform with mc space;

FIG. 5B is a diagram of a mapping into mc space shown to describe Hough transform with m-c space;

FIG. 6A is a diagram of parameters è, and ñ shown to describe Hough transform with èñ space;

FIG. 6B is a diagram of a mapping into èñ space shown to describe Hough transform with èñ space;

FIG. 7 is an explanatory diagram of application of Hough transform to an image which is geometrically converted and divided into upper and lower areas by the diagrammatizing apparatus for vehicle lane detection according to the embodiment of the present invention;

FIG. 8 is a schematic diagram of parameter space of Hough transform of FIG. 7;

FIG. 9 is a schematic diagram of an area where lines intersect with each other in the parameter space of Hough transform of FIG. 7;

FIG. 10 is a schematic diagram of an example of positional relation among a plurality of edge lines formed from edge points which are present in the image of FIG. 7;

FIG. 11 is an explanatory diagram of an outline of edge line extraction by the diagrammatizing apparatus for vehicle lane detection according to the embodiment of the present invention;

FIG. 12 is a block diagram of a structure of a driving support system according to one embodiment to which the diagrammatizing apparatus for vehicle lane detection according to the embodiment of the present invention is applied;

FIG. 13 is a schematic diagram of a vehicle and sign lines to be processed by the diagrammatizing apparatus for vehicle lane detection according to the embodiment of the present invention;

FIG. 14 is a schematic diagram of a vehicle, on which a camera is mounted, to which the diagrammatizing apparatus for vehicle lane detection according to the embodiment of the present invention is applied;

FIG. 15 is a schematic diagram of an image picked up by a camera in the diagrammatizing apparatus for vehicle lane detection according to the embodiment of the present invention;

FIG. 16 is a graph of an example of luminance data corresponding to positions of respective pixels along a predetermined horizontal line to be dealt with by the diagrammatizing apparatus for vehicle lane detection according to the embodiment of the present invention;

FIG. 17 is a graph of an example of data of luminance derivative values corresponding to positions of respective pixels along the predetermined horizontal line to be dealt with by the diagrammatizing apparatus for vehicle lane detection according to the embodiment of the present invention; and

FIG. 18 is a diagram shown to describe a method of detecting a boundary of a sign line in a conventional diagrammatizing apparatus for vehicle lane detection.

### BEST MODE(S) FOR CARRYING OUT THE INVENTION

In the following, a sign line detector will be described in detail as an embodiment of the diagrammatizing apparatus for vehicle lane detection of the present invention with reference to the accompanying drawings. The sign line detector according to the embodiment is applied to a driving support system that performs lane keeping operation.

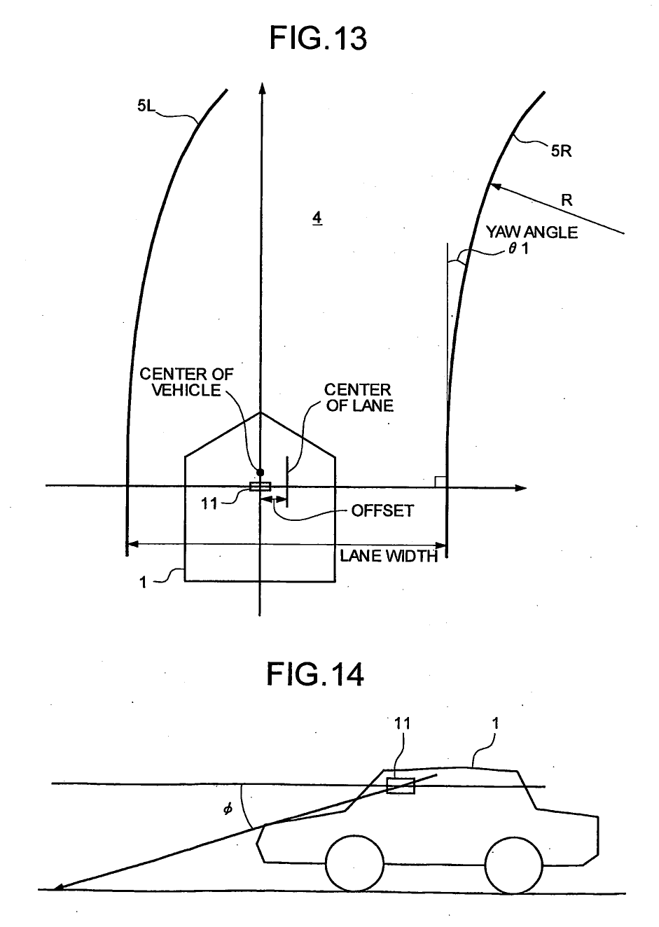

FIG. 13 is a plan view of a vehicle 1 to which the sign line detector according to the embodiment is applied. FIG. 14 is a side view of the vehicle 1. As shown in FIGS. 13 and 14, a charge coupled device (CCD) camera 11 is provided for image pick-up in a front part of the vehicle 1, e.g., to a center of an interior of the vehicle 1 (around a room mirror). The CCD camera 11 is arranged so that the CCD camera 11 forms a depression angle φ with a horizontal direction as shown in FIG. 14.

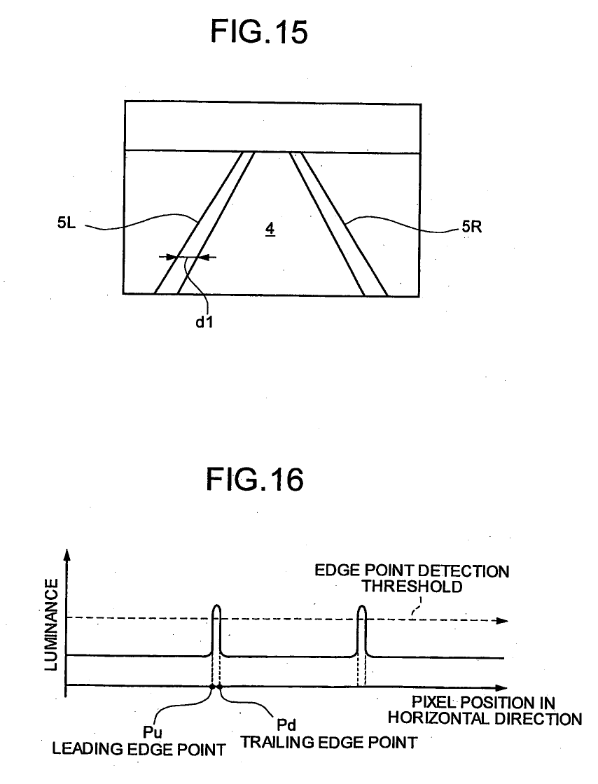

The CCD camera 11 serves to acquire an image (video) of a road surface ahead the vehicle 1 in a manner shown in FIG. 15. The CCD camera 11 is arranged so that an image pick-up range thereof covers an area of a left white line 5L and a right white line 5R which represent boundary lines, i.e., positions of boundaries defined by lane signs, of a lane 4 on which the vehicle 1 runs.

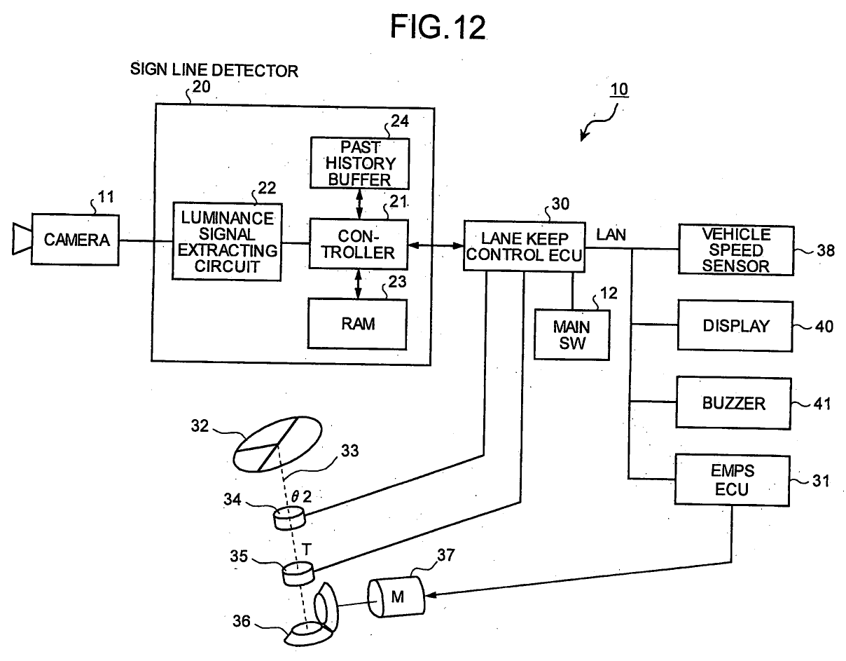

FIG. 12 is a schematic diagram of a structure of a driving support system 10 to which a sign line detector 20 according to the embodiment is applied. As shown in FIG. 12, the driving support system 10 includes the CCD camera 11, a main switch 12, the sign line detector 20, a lane keep control electronic control unit (ECU) 30, a vehicle speed sensor 38, a display 40, a buzzer 41, a steering torque control ECU (driving circuit) 31, a steering angle sensor 34 and a torque sensor 35 arranged on a steering shaft 33 connected to a steering wheel 32, and a motor 37 connected to the steering shaft 33 via a gear mechanism 36.

The CCD camera 11 outputs the acquired image to the sign line detector 20 as an analog video signal. The main switch is an operation switch manipulated by a user (driver, for example) to start/stop the system, and outputs a signal corresponding to the manipulation. The lane keep control ECU 30 outputs a signal that indicates an operative state to sign line detector 20 so that the driving support system (driving support system 10) starts up when the main switch 12 is turned over from OFF state into ON state.

The display 40 is provided on an instruction panel in the interior of the vehicle 1 and driven to light up by the lane keep control ECU 30 to allow the user to check the operation of the system. For example, when the sign lines 5L and 5R are detected on respective sides of the vehicle 1, the lane keep control ECU 30 drives the display 40 to light up. The buzzer 41 is driven to make sound by the lane keep control ECU 30 when it is determined that the vehicle is likely to deviate from the lane.

The sign line detector 20 includes a controller 21, a luminance signal extracting circuit 22, a random access memory (RAM) 23, and a past history buffer 24.

The luminance signal extracting circuit 22 receives the video signal from the CCD camera 11, extracts a luminance signal, and outputs the same to the controller 21. Based on the signal sent from the luminance signal extracting circuit 22, the controller 21 performs processing such as detection of the sign lines 5L and 5R, calculation of road parameters (described later), detection of a curve R of the lane 4, a yaw angle è1, and an offset as shown in FIG. 13. At the same time, the controller 21 temporarily stores various data related with the processing in the RAM 23. The controller 21 stores a width of the detected sign lines 5L and 5R, and the calculated road parameters in the past history buffer 24.

Here, the yaw angle è1 is an angle corresponding to a shift between a direction in which the vehicle 1 runs and a direction of extension of the lane 4. The offset is an amount of shift between a central position of the vehicle 1 and a central position of the width of the lane 4 (lane width) in lateral direction. The sign line detector 20 outputs information indicating the positions of the sign lines 5L and 5R, and information indicating the curve R, yaw angle è1, and the offset to the lane keep control ECU 30.

Based on the road parameters, the positions of the sign lines 5L and 5R, the curve R, the yaw angle è1, and the offset which are supplied from the sign line detector 20 and a speed of the vehicle supplied from the vehicle speed sensor 38, the lane keep control ECU 30 calculates a steering torque necessary to allow the vehicle 1 pass through the curve, and performs processing such as detection of deviation from the lane 4. The lane keep control ECU 30 outputs a signal that indicates the calculated necessary steering torque to the steering torque control ECU 31 for the driving support. The steering torque control ECU 31 outputs a command signal corresponding to the received steering torque to the motor 37. In addition, the lane keep control ECU 30 outputs a driving signal to the buzzer 41 according to the result of detection of lane deviation to drive the buzzer 41 to make sound.

The steering angle sensor 34 outputs a signal corresponding to a steering angle è2 of the steering wheel 32 to the lane keep control ECU 30. The lane keep control ECU 30, based on the signal supplied from the steering angle sensor 34, detects the steering angle è2. The torque sensor 35 outputs a signal corresponding to a steering torque T transmitted to the steering wheel 32 to the lane keep control ECU 30. The lane keep control ECU 30, based on the signal supplied from the torque sensor 35, detects the steering torque T. The gear mechanism 36 transmits a torque generated by the motor 37 to the steering shaft 33. The motor 37 generates a torque corresponding to a command signal supplied from the steering torque control ECU 31.

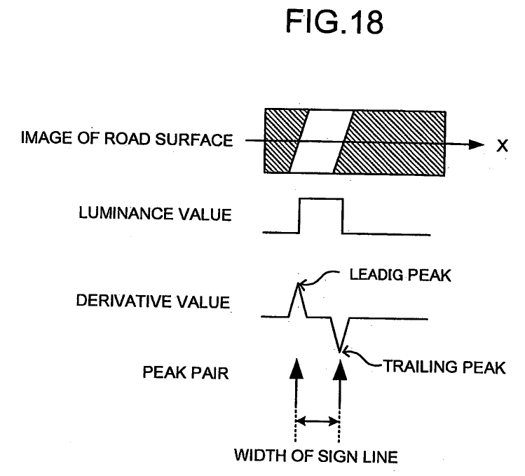

Next, with reference to FIG. 18, a basic manner in which the sign line detector 20 detects a sign line from an image picked up by the CCD camera 11 will be described. When one line, e.g., the sign line 5L or the sign line 5R is to be detected, if the width of the sign line is found according to a manner shown in FIG. 18, for example, the width and the position of the sign line are detected. As shown in FIG. 18, the width of the sign line is found based on rising and falling of respective luminance values of a plurality of pixels arranged on a line running in a horizontal direction X which is substantially orthogonal to a direction of vehicle running (a direction of extension of the sign line, i.e., the vertical direction in FIG. 18) in a road surface image. Alternatively, deviation of luminance values of pixels adjacent to each other on the line of the horizontal direction X is calculated as luminance derivative values, and the width of the sign line is found according to the rising peak and the falling peak thereof as shown in FIG. 18.

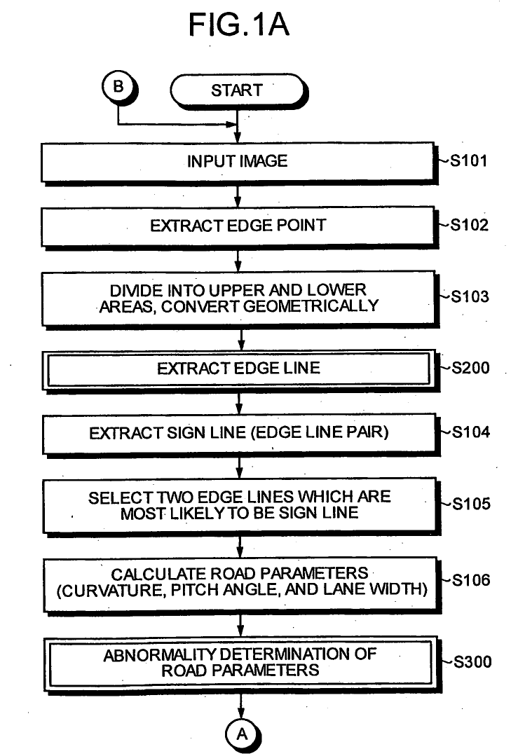

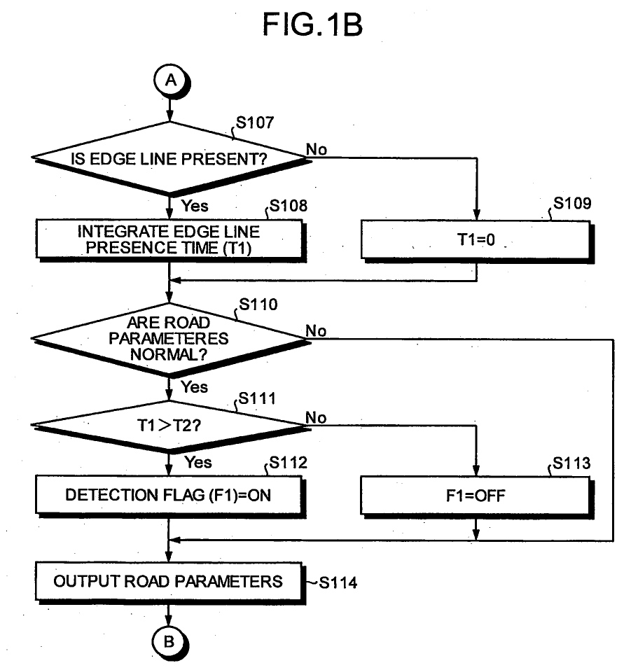

FIGS. 1A to 3 are flowcharts of vehicle lane detection according to the embodiment. The process is repeated every predetermined time period as a scheduled interruption as far as the main switch 12 is ON. When the process reaches this routine, the controller 21 performs input processing of various data.

Next, the controller 21 performs input processing of video taken by the camera 11 at step S101. Specifically, the controller 21 receives the luminance signal extracted from the video signal of the CCD camera 11 and analog/digital (A/D) converts the same for every pixel, and temporarily stores the results in the RAM 23 as luminance data associated with pixel positions. The pixel position is defined according to the image pick-up range of the CCD camera 11 (see FIG. 15).

The luminance data takes a higher value when the corresponding luminance is lighter (whiter) and takes a lower value when the corresponding luminance is darker (blacker). For example, the luminance data may be represented by 8 bits (0-255), where the brighter luminance is closer to the value “255” while the darker luminance is closer to the value “0.”

Next, the controller 21 moves to step S102 to perform the edge point extraction (candidate white line point detection). Specifically, the controller 21 reads out (scans) the luminance data of respective pixel temporarily stored in the RAM 23 sequentially for each horizontal line. In other words, the controller 21 collectively reads out the luminance data of pixels whose pixel positions are arranged on a horizontal direction from the RAM 23. FIG. 16 is a graph of an example of luminance data corresponding to respective pixel positions on a predetermined line in the horizontal direction.

As shown in FIG. 16, the luminance data of respective pixels arranged along the horizontal direction shows peaks at which the luminance is lighter in positions corresponding to the left white line 5L and the right white line 5R of the vehicle 4, for example (similarly to the luminance values of FIG. 18). Then, the controller 21 compares the luminance data of each horizontal line with an edge point detection threshold to extract a candidate pixel position corresponding to the sign line (edge point, white line candidate point). The controller 21 extracts edge points for a predetermined number (or all) of horizontal lines. The controller 21 temporarily stores all the extracted edge points (pixel positions) in the RAM 23.

An edge point where the luminance changes from “dark” to “light” is referred to as a leading edge point Pu, whereas an edge point where the luminance changes from “light” to “dark” is referred to as a trailing edge point Pd. The detection of a pair of the leading edge point Pu and the trailing edge point Pd completes the detection of one sign line. The distance between the leading edge point Pu and the trailing edge point Pd of the pair corresponds with the width (denoted by reference character d1 in FIG. 15) of one sign line. As shown in FIGS. 15 and 16, when two pairs of leading edge point Pu and trailing edge point Pd are present on a single horizontal line, respective pairs correspond with the left white line 5L and the right white line 5R of the lane 4. In actual detection, however, edge points (not shown) other than the edge points corresponding to the left white line 5L and the right white line 5R are often detected because of the presence of noise, and shadows of vehicles, buildings, or the like.

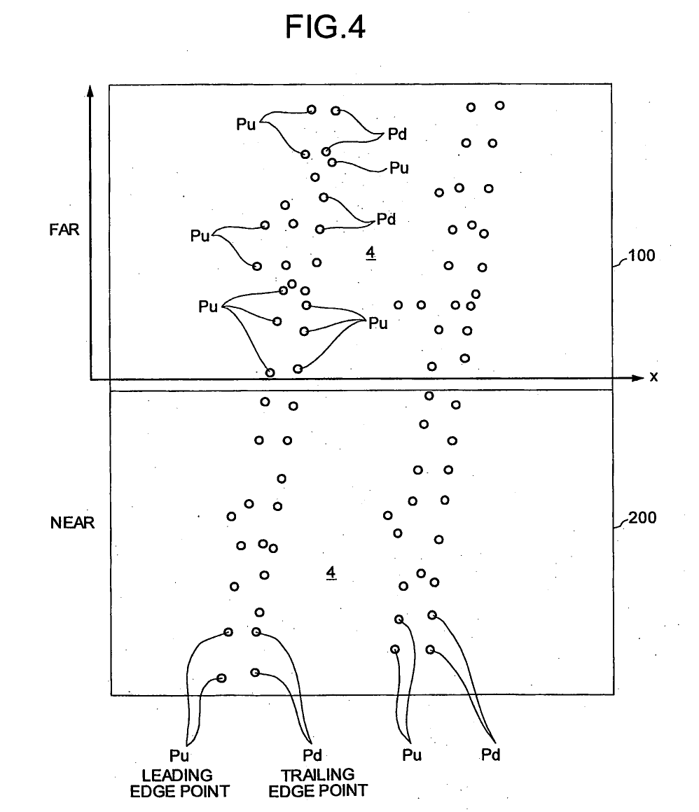

Next, the controller 21 proceeds to step S103 where the image after the process of step S102 is divided into an upper half area (which represents farther area from the vehicle 1) and a lower half area (which represent closer area to the vehicle 1). The geometric conversion is conducted on each of the upper half area and the lower half area to generate a road surface image with an upper half area 100 and a lower half area 200 in the format as shown in FIG. 4. When used herein, the geometric conversion means analysis of an image picked up by the camera 11 and generation of a road surface image which represents the road surface as if the road is viewed from vertically upward position (a plan view of the road surface).

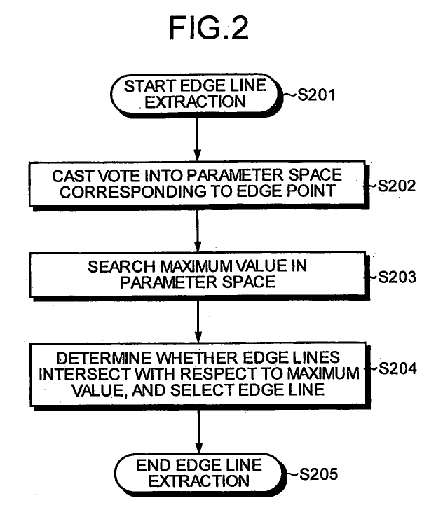

Next, the controller 21 proceeds to a subroutine of step S200 where the edge line extraction (extraction of a candidate white line straight line) of FIG. 2 is performed. First, a technical premise for the edge line extraction will be described.

The controller 21 reads out the edge points temporarily stored in the RAM 23 and applies a group of points to a straight line (i.e., derives a line from edge points). As a technique to apply points to a line, Hough transform, for example, is known from Takashi Matsuyama et al. “Computer Vision, 149/165 Shin-Gijutsu Communications: 1999,” and P. v. c. Hough, “Methods and means for recognizing complex patterns, U.S. Pat. No. 3,069,654 (1962).”

The Hough transform is a representative technique which allows the extraction of diagram (straight line, circle, oval, parabola, for example) that can be represented with parameters. The technique has an excellent feature that a plurality of lines can be extracted and is highly tolerant for noises.

As an example, detection of a straight line is described. The straight line can be represented with the following Equation (1) using a gradient m and a segment c of y-axis as parameters,

y=mx+c (1)

Or with the following Equation (2) using a length ñ of a perpendicular running from the origin up to the straight line, and angle è formed by the perpendicular and x-axis as parameters,

ñ=x cos è+y sin \tilde{e} (2).

First, a technique using Equation (1) will be described.

A point (x₀,y₀) on the straight line satisfies Equation (1) and the following Equation (3) holds,

y₀=mx₀+c (3)

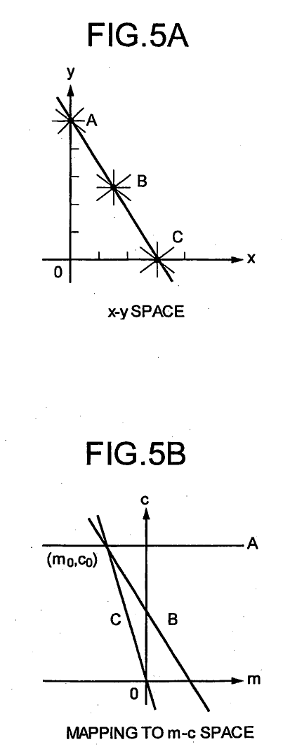

Here, assume that (m,c) is a variable, a straight line on an mc plane can be derived from Equation (3). If the same process is performed for all pixels on one line, a group of derived straight lines on the mc plane will concentrate on one point (m₀,c₀). This intersecting point represents the value of sought parameter. FIGS. 5A and 5B are shown to describe Hough transform with mc space FIG. 5A represents the xy space whereas FIG. 5B represent mapping to the mc pace. As shown in FIGS. 5A and 5B, a group of straight lines that run through points A, B, and C are represented by straight lines A, B, and C in the mc plane and the coordinate of their intersecting point is represented as (m₀,c₀)

The foregoing is the basic technique for detection of straight lines with Hough transform. Specifically, the intersecting point is found as follows. A two-dimensional array corresponding to the mc space is prepared. Manipulation of drawing a straight line in the mc space is replaced with a manipulation of adding one to an array element through which the straight line runs. After the manipulation is done for all edge points, an array element with large cumulative frequency is detected and the coordinate of the intersecting point is found.

Next, a technique using Equation (2) will be described.

A coordinate (x₀,y₀) on the straight line satisfies the following Equation (4):

ñ=x₀ cos è+y₀ sin è (4)

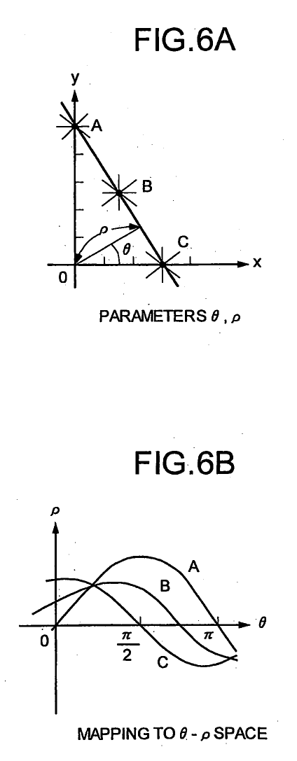

Here, as shown in FIG. 6A, the reference character ñ represents a length of a vertical line running from the origin to the straight line, è represents an angle formed by the vertical line and the x-axis. With the equation, a group of straight lines running through one point on the x-y plane forms a sine wave on the èñ plane, and the group of straight lines running through points A, B, and C in FIG. 6A appear as shown in FIG. 6B. Here, the straight lines also intersect at one point. If the group of points in the xy coordinate are represented as pᵢ(xᵢ,yᵢ) where i=1−n, the point pi can be converted into a curve in the parameter (è,ñ) space,

ñ=x cos è+y sin è (5)

When a function p(è,ñ) is defined, which represents a frequency of passing of the curve through a point in the parameter space with respect to the respective point, one is added to p(è,ñ) with respect to (è,ñ) which satisfies Equation (5). This is called a vote casting to the parameter space (vote space). The plurality of points constituting the straight line in the x-y coordinate forms a curve running through the point (è₀,ñ₀) representing the straight line in the parameter space. Thus p(è₀,ñ₀) has a peak at the intersecting point. Hence with the peak detection, the straight line can be extracted. Generally, a point is determined to be a peak when the point satisfies the relation p(è,ñ) n₀, where n₀ is a predetermined threshold.

At step S200, with Hough transform on the edge point extracted at step S102, the edge line is extracted. Here, one edge line (straight line) is constituted only from the plurality of leading edge points Pu (i.e., trailing edge points Pd are excluded). The edge line constituted only from the leading edge points Pu is referred to as a leading edge line, whereas the edge line constituted only from the trailing edge points Pd is referred to as a trailing edge line. As a result of step S102, edge points (not shown) other than the edge points of the left white line 5L and the right white line 5R are often detected. Hence, as a result of Hough transform, edge lines (not shown) other than the edge lines corresponding to the left white line 5L and the right white line 5R are often detected in the upper half area 100 or the lower half area 200.

An object of the embodiment is to suppress the extraction of edge lines (including the edge lines formed by the noise or the shadow) other than the edge lines corresponding to the left white line 5L and the right white line 5R at the step of edge line extraction (step S200).

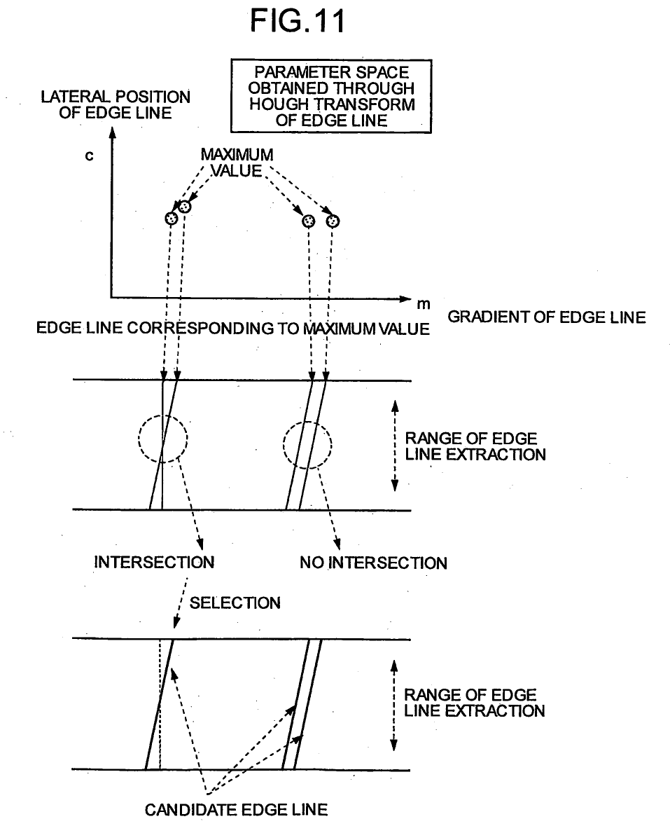

With reference to FIG. 11, an outline of the edge line extraction at step S200 will be described.

In the conventional sign line detector, a point where the vote value in the parameter space is a local maximum is extracted as a candidate edge line via Hough transform for extraction of an edge line which is a candidate lane boundary line. When the actual image is processed, however, a false local maximum value is sometimes extracted as a noise. In the embodiment, with the use of edge line characteristics, i.e., that the edge line corresponding to the lane boundary line do not intersect with each other at least in the range of edge line extraction. Thus, the extraction of such unnecessary edge line is suppressed and the reliable detection of sign lines and the reduction in processing cost will be realized.

Next, with reference to FIGS. 2 and 4, step S200 will be described in detail.

The controller 21 starts the edge line extraction (at step S201). Here, edge line extraction is performed only on the leading edge point Pu and not on the trailing edge point Pd. However, the edge line extraction is also possible on the trailing edge point Pd in the same manner as described below. Additionally, the search area for the edge line extraction here is the upper half area 100 alone and does not include the lower half area 200. The edge line extraction on the lower half area 200 as the search area can be also performed separately, in the same manner as described below.

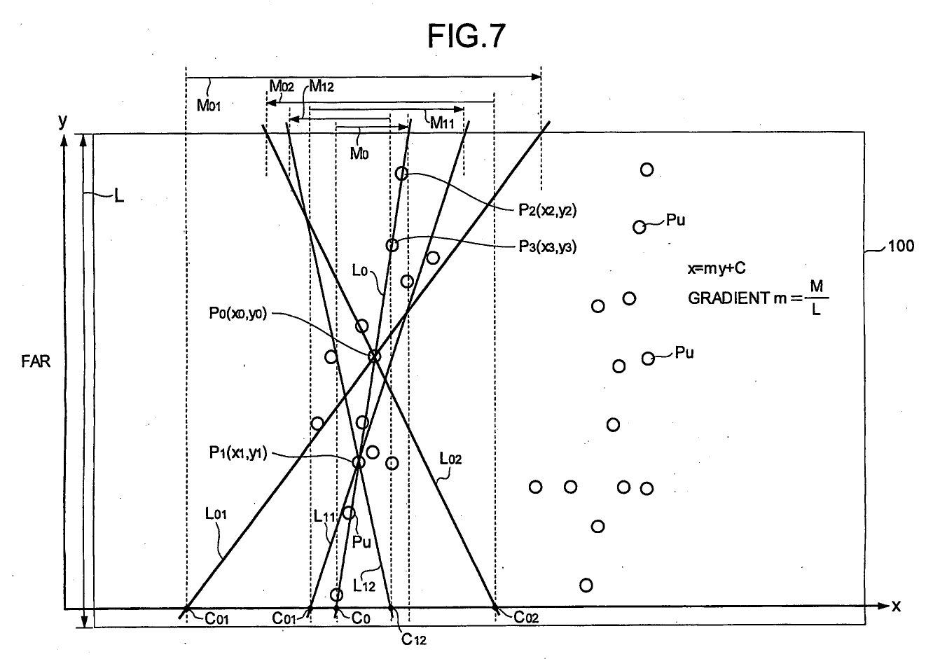

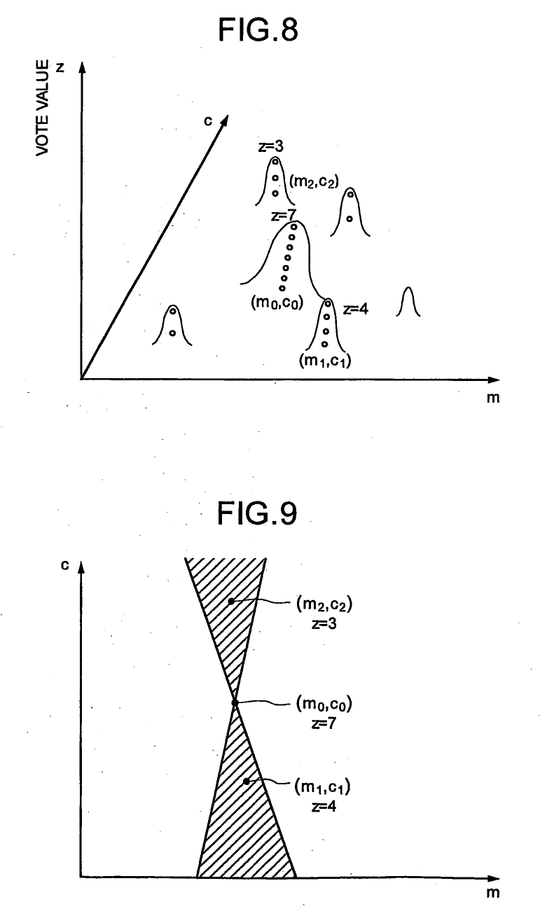

Next, the controller 21 proceeds to step S202 where the controller 21 performs a vote casting on the parameter space with respect to each one of edge points. A specific processing at step S202 will be described below with reference to FIGS. 7 and 8. The edge points shown in FIG. 7 are the leading edge points Pu of the upper half area 100 of FIG. 4 which is the search area determined at step S201.

Here, the straight line is represented by the equation x=my+c where gradient m and segment c of the x-axis are used as parameters. As shown in FIG. 7, all the lines will be considered which are likely to pass through each edge point among the plurality of edge points pᵢ(xᵢ,yᵢ) where i=1−n in the x-y coordinate. For example, straight lines L₀₁, L₀₂, . . . which are likely to pass through edge point p₀(x₀,y₀) are defined with gradients m₀₁, m₀₂, . . . (=M₀₁,M₀₂, . . . /L) and segment with the x-axis c₀₁, c₀₂, . . . . Straight lines L₁₁, L₁₂, . . . passing through another edge point p₁(x₁,y₁) is defined with gradients m₁₁, m₁₂, . . . (=M₁₁,M₁₂, . . . /L) and segments with the x-axis c₁₁, C₁₂, . . . . Straight line L₀which passes through both the edge point p₀(x₀,y₀) and the another edge point p₁(x₁,y₁) are defined with the gradient m₀ (=M₀/L) and the segment c₀ with the x-axis.

At step S202, the controller 21 finds the gradient m and the x-axis segment c for all straight lines which are likely to pass through an edge point with respect to each edge point (leading edge point Pu alone in the embodiment) among the plurality of edge points in the x-y coordinate of the upper half area 100 and casts vote to the mc space (parameter space) as shown in FIG. 8. In FIG. 8, z represents a vote value which corresponds with the number of edge points.

In an example shown in FIG. 7, at least all of four edge points p₀-p₃are on the straight line L₀whose gradient and x-axis segment are defined as m₀ and c₀. Hence, at least four votes are cast for (m₀,c₀) in the parameter space of FIG. 8. Thus, when votes in the parameter space are cast for all straight lines which are likely to pass through an edge point with respect to all edge points, a plurality of peaks (local maximum values) are formed in the parameter space as shown in FIG. 8.

Next, the controller 21 proceeds to step S203 and searches the peaks (local maximum values) in the parameter space of FIG. 8 (the search area set at step S201: here, upper half area 100 alone). As shown in FIG. 8, the plurality of peaks is formed in the parameter space.

Each of the plurality of peaks generated in the parameter space of FIG. 8 corresponds with an edge line extracted from edge points in the x-y coordinate of the upper half area 100. The Z value of the peak corresponds with the number of edge points which are present on the edge line extracted in the x-y coordinate.

In step S203, a threshold is set with respect to the value of the vote value Z. Only the peaks, to which more votes than the predetermined threshold are cast, are selected. Here, if two is set as the threshold of Z, for example, three points (m₀,c₀), (m₁,c₁), and (m₂,c₂) are selected from the plurality of peaks in the parameter space as the peaks with the vote value Z higher than the threshold.

Next, the controller 21 proceeds to step S204, where the controller 21 performs an intersection determination between the edge lines with respect to the local maximum value and selection of the edge lines. In step S204, the edge lines which intersect with each other are sought among the edge lines which have larger vote value Z than the threshold set in step S203 in the parameter space (search area set in step S201).

In the parameter space, the straight lines which intersect with each other have a particular geometric characteristic. A shaded area (intersection area indicating section) in the parameter space shown in FIG. 9 indicates an area where the straight line intersects with the straight line defined by (m₀,c₀) (an area designated by the above mentioned geometric characteristic) in the processing area of the x-y coordinate. Since the shaded area of FIG. 9 can be readily found mathematically, the description thereof will not be given.

In step S204, if there are plural peaks which are searched in step S203 and have the local maximum value larger than the threshold, the controller finds the shaded area of FIG. 9 for the respective peaks and determines whether other peaks sought in step S203 are included in the shaded area or not (intersection determination of edge lines).

At the same time, the controller 21 deletes the peaks which have a smaller vote value Z than the peak for which the shaded area is set (peak (m₀,c₀) in FIG. 9) in the shaded area (selection of edge line). In the example of FIG. 9, since the peaks (m₁,c₁) and (m₂,c₂)have a smaller vote value Z, (m₁,c₁) and (m₂,c₂) are deleted and (m₀,c₀) alone is left.

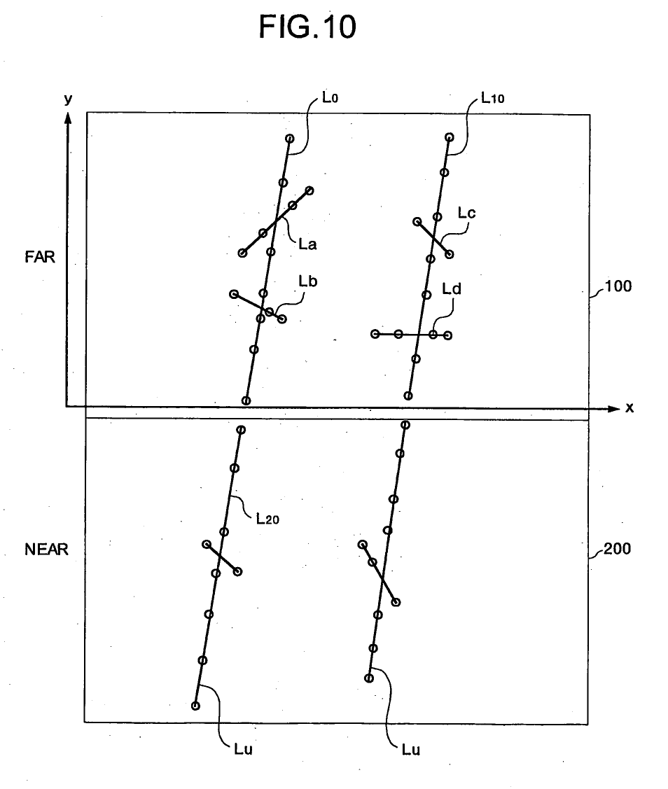

In the x-y coordinate shown in FIG. 10, straight lines L₀ (see FIG. 7), Lₐ, and L_{b} intersect with each other. Here, the straight line L₀ corresponds with (m₀,c₀) where Z=7 in FIGS. 7 to 9 (i.e., the number of edge lines on the straight line L₀in FIGS. 7 and 10 is seven). The straight line La corresponds with (m₁,c₁) where Z=4 in FIGS. 8 and 9 (i.e., the number of edge points on the straight line La in FIG. 10 is four). The straight line Lb corresponds with (m₂,c₂) where Z=3 in FIGS. 8 and 9 (i.e., the number of edge points on the straight line Lb in FIG. 10 is three).

In other words, the straight lines La and Lb corresponding respectively with (m₁,c₁) and (m₂,c₂) in the shaded area set for (m₀,c₀) in FIG. 9, are shown to intersect with the straight line L₀ in FIG. 10. In FIG. 9, L₀ with the largest vote value Z among the straight lines L₀, La, and Lb which intersect with each other is selected, in other words, a straight line which is most likely to be the edge line indicating the boundary of the sign line or the lane is selected in FIG. 9. Then, the edge lines which do not correspond with the boundary of the sign line or the lane are deleted.

As described above, in the embodiment, the characteristic of the edge line pair is utilized that an edge line pair which corresponds with the boundary of the lane (indicated by the reference number 4 in FIGS. 4, 13, and 15) or an edge line pair which corresponds with the sign line (i.e., the leading edge line and the trailing edge line) includes parallel edge lines. Here, “parallel” means that the lines do not intersect with each other in the processing area (each of the upper half area 100 and the lower half area 200 in the example). In other words, the same edge point is not included in plural straight lines (edge lines) which constitute the sign line.

As shown in FIG. 10, when the plurality of edge lines L₀, La, and Lb intersect with each other in the processing area 100, at least the edge lines La and Lb other than the line L₀ among the group of edge lines L₀, La, and Lb which intersect with each other is not an edge line constituting the boundary of the sign line or the lane. Hence, these lines are noises or generated as a result of detection error caused by an object such as a shadow of a vehicle.

Further, the edge line L₀ constituting the boundary of the sign line or the lane among the group of edge lines L₀, La, and Lb which intersect with each other is the longest, since the edge line L₀ constitutes the boundary of the sign line or the lane. When the group of edge lines L₀, La, and Lb can be detected and the longest edge line L₀ is selected based on the characteristic described above, the edge line which is most likely to constitute the boundary of the sign line or the lane can be selected.

To clarify the processing described above, another example is described. An edge line L₁₀ which is most likely to be the edge line constituting the boundary of the lane or the sign line is detected as a result of, firstly, detection of a group of edge lines L₁₀, Lc, and Ld which intersect with each other, and secondly, selection of an edge line which is the longest among the lines in the detected group.

Here, since the above mentioned processing is performed per search area set in step S202, the edge line L₀ constituting the sign line in the upper half area 100 and an edge line L₂₀ which is located on the same straight line as the edge line L₀ in the lower half area 200 are detected as different straight lines in separate processing.

In the embodiment, the object of edge line extraction in step S201 is the leading edge point Pu alone. However, since the lane boundary is the boundary line of the driving lane and the sign line, the leading edge point Pu (leading edge line) may be found by the processing of the right half of the road surface image, whereas the trailing edge points Pd (trailing edge line) may be found by the processing of the left half of the road surface image respectively as the first and the second edge lines (line of points) which do not intersect with each other.

In the foregoing, a technique to focus on the vote value Z in step S204 is described as a technique for selecting the longest edge line among the group of edge lines which intersect with each other. The technique is based on the characteristic of the edge line that the longer edge line has more edge points thereon. The technique for selecting the longest edge line among the group of edge lines which intersect with each other, however, is not limited to the one described above which focus on the vote value Z in step S204. The following technique, for example, can be adopted.

The controller 21 refers to the coordinate values on the x-y coordinate of each of seven edge points cast as the votes to the line for which the shaded area of FIG. 9 is set ((m₀,c₀) in FIG. 9), and finds a distance between two edge points located farthest from each other among seven edge points. The distance corresponds with the distance between two edge points located farthest from each other among seven edge points on the edge line L₀ shown in FIG. 10, i.e., the length of edge line L₀. Next, the controller 21 finds the distance between two edge points located farthest from each other among four edge points of (m₁,c₁) in the shaded area of FIG. 9. The distance corresponds with the distance between two edge points located farthest from each other among four edge points on the edge line La shown in FIG. 10, i.e., the length of the edge line La. Similarly, the controller 21 finds the length of the edge line Lb corresponding to (m₂,c₂) in the shaded area of FIG. 9. Next, the controller 21 compares the length of the edge lines L₀, La, and Lb to select the longest edge line L₀.

Further, as a technique to select the longest edge line among the group of edge lines which intersect with each other, an effective technique is to select an edge line where the distance between the two edge points located farthest from each other among the edge points on the subject line is long, and the number of edge points (vote value Z) on the subject edge line is large. This is because edge lines with a large physical distance and representing the difference of light and dark in the large number of edge points are most likely to be the boundary lines of the sign line or the lane. Thus, the edge lines can be selected based on the evaluation function of the physical distance between the edge lines and the vote value Z.

In the edge line extraction in step S200 described above, the plurality of edge lines are extracted from the group of edge points extracted from the image via Hough transform. Then, the group of edge lines which intersect with each other is selected from the extracted plural edge lines, and the longest edge line in the group is selected as the edge line which constitutes the boundary of the sign line or the lane. Here, the diagrammatization can be performed by technique other than Hough transform which is adopted in step S200.

For example, in place of Hough transform, a technique of least square method may be adopted to apply the group of edge points to the straight line. According to the method, plural edge lines are extracted, a group of edge lines which intersect with each other among the extracted plural edge lines is detected, and the longest edge line in the group is selected as the edge line constituting the boundary line of the sign line or the lane.

Alternatively, in place of Hough transform, various techniques including a technique using eigenvector such as feature extraction may be adopted to apply the group of edge lines to the straight line, to extract the plural edge lines, to extract the group of edge lines which intersect with each other among the extracted plural edge lines, and to select the longest edge line in the group as an edge line constituting the boundary line of the sign line or the lane.

According to edge line extraction of the embodiment, the extraction of unnecessary candidate edge line is suppressed. Thus, the processing cost is reduced, therefore the embodiment is advantageous for the reliable detection of the sign line or the lane. Conventionally, the edge line processing as in the embodiment (particularly the processing in step S204) is not performed and the unnecessary candidate edge lines are extracted as well. Hence, in the subsequent lane selection, pairing of the edge lines is performed also with the unnecessary candidate edge lines, and the most reliable pair needs to be selected from among these pairs. Thus the processing cost is high.

In the foregoing, step S200 is described as a technique for extracting an edge line of the sign line by the sign line detector 20. The line extraction technique described with reference to step S200 is applicable for the extraction of lines other than the sign line. In other words, the line extracting technique of step S200 is applicable when the line is extracted from an image, in particular, when points such as edge points arranged in a line is extracted, as far as the feature parameter of the object to be extracted is “the plural lines which do not intersect with each other and have a large length.”

Next, the controller 21 proceeds to step S104 where the controller 21 performs sign line (edge line pair) extraction. Specifically in step S200, only the edge lines which do not intersect with each other are extracted, and the controller 21 extracts a pair (edge line pair) of the leading edge line and the trailing edge line from the extracted plurality of edge lines. In step S200, only the parallel edge lines which do not intersect with each other is extracted. However, since edge lines (not shown) other than the edge lines corresponding to the left white line 5L and the right white line 5R are often detected, there are more than one combination of pairs of leading edge lines and trailing edge lines.

In step S104, the controller 21 refers to an allowable width of the sign line and extracts an edge line pair which distance (reference character d1 of FIG. 15) between the leading edge line and the trailing edge line constituting the edge line pair is within the allowable width (not shown) of the sign line from among the plural edge line pairs including edge line pairs other than the edge line pair corresponding to the left white line 5L and the right white line 5R.

For example, if the allowable width ds of the sign line is set to 0-30 cm, and the distance between the leading edge line and the trailing edge line is 50 cm, the pair does not fall within the range of allowable width of the sign line, whereby the pair is not extracted as the edge line pair (i.e., excluded from the candidate sign line with respect to the width dimension). On the other hand, if the distance d1 between the leading edge line and the trailing edge line is 20 cm, the value falls within the allowable width of the sign line and the pair is extracted as the edge line pair (i.e., selected as the candidate sign line with respect to the width dimension).

Next, the controller 21 proceeds to step S105, where the controller 21 selects two edge line pairs which are most likely to be the sign line from among the candidate sign lines selected from the extracted plural edge line pairs (straight lines) in step S104. One edge line pair is selected for each pixel position corresponding to the sides of the vehicle 1. At the selection of the edge line pair, the pitch angle, the roll angle, the yaw angle of the vehicle 1, and the lateral moving distance obtained from the previous detection are considered, for example. In other words, the range the vehicle 1 is movable in a predetermined time period is considered. The edge line pair which is selected in step S105 is selected as the candidate sign line in view of the consistency with the result of previous detection, i.e., so as to reflect the result of previous detection. The controller 21 temporarily stores the selected pair of sign lines (edge line pair) in correspondence with the pixel position in the RAM 23.

Next, the controller 21 proceeds to step S106 and calculates the road parameters (curvature, pitch angle, and lane width). Here, based on the data of two straight edge lines which are extracted in step S105 as the most likely candidates, the controller 21 derives the corresponding edge point data. Then, based on the derived edge point data, the controller calculates the road parameters (curvature, pitch angle, and lane width).

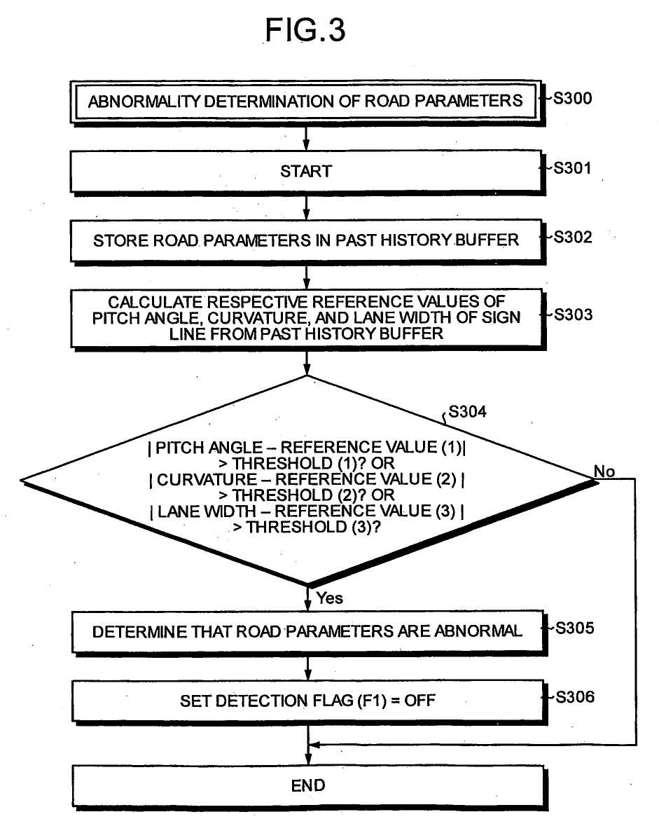

Next, the controller 21 proceeds to the subroutine in step S300 to perform abnormality determination of the road parameter shown in FIG. 3. The controller 21, after starting the abnormality determination of the road parameters, stores the past road parameters (pitch angle, curvature, and lane width) in the past history buffer 24 (in step S302).

Then, the controller 21 proceeds to step S303 where the controller 21 reads out the plurality of road parameters (pitch angle, curvature, and lane width) and finds respective reference values of the pitch angle, the curvature, and the lane width based on the read out plurality of road parameters. The reference values of the pitch angle, the curvature, and the lane width may be average values of the plurality of pitch angle, curvature, and lane width.

The controller then proceeds to step S304 to perform the following operations. The controller finds the absolute value of the difference between the pitch angle found in step S106 and the reference value (1) of the pitch angle found in step S303; and determines whether the absolute value is larger than the threshold (1). The controller 21 also finds the absolute value of the difference between the curvature found in step S106 and the reference value (2) of the curvature found in step S303; and determines whether the absolute value is larger than the threshold (2). Further, the controller 21 finds the absolute value of the difference between the lane width found in step S106 and the reference value (3) of the lane width found in step S303; and determines whether the absolute value is larger than the threshold (3) (in step S304).

As a result of the determination in step S304, if at least one of the conditions is met, i.e., the absolute value is larger than the threshold for at least one road parameters, the controller 21 proceeds to step S305 to determine that the road parameter is abnormal.

Then the controller 21 moves to step S306 where the controller 21 sets a detection flag (F1) to OFF and ends the subroutine of the abnormality determination of the road parameters of step S300. On the other hand, if any of three conditions are not met as a result of the determination in step S304, the controller 21 ends the subroutine of the abnormality determination of the road parameters of step S300 without going through steps S305 and S306.

The controller 21 then proceeds to step S107 of FIG. 1B to determine whether the edge line to be selected in step S105 or the edge line selected in step S105 is present or not. When the road is dirty, for example, the sign line may not be seen covered by dirt or the like, or the boundary line of the sign line or the lane may be blurred to hamper the detection of the boundary line of the sign line or the lane. In such cases, the corresponding edge line cannot be extracted, and the controller 21 determines that the edge line is not present in step S107. In step S107, if the detection flag (F1) is OFF (in step S306, step S113 described later) the controller 21 determines that the edge line is not present. Step S107 also serves to make “lost” detection of the edge line.

As a result of step S107, if the controller 21 determines that the edge line is present, an edge line presence time (T1), which indicates the time period of consecutive presence of the edge line, is added (step S108). On the other hand, if the controller 21 determines that the edge line is not present as a result of the determination in step S107, the edge line presence time (T1) is set to zero (step S109).

Then, the controller 21 proceeds to step S110, and determines whether the road parameters are normal or not. The determination is made based on the abnormality determination of the road parameters in step S300 as described above. If the controller 21 determines that the road parameters are normal as a result of determination in step S110, the controller moves to step S111, and otherwise moves to step S114.

In step S111, the controller 21 determines whether the edge line presence time (T1) is longer than a required detection time (T2) or not. In other words, it is determined whether the edge line presence time (T1), which indicates the time period the edge line to be selected in step S105 or the edge line selected in step S105 is consecutively present (including “not lost”), is longer than the required detection time (T2) or not. If the edge line presence time (T1) is longer than the required detection time (T2) as a result of the determination in step S111, the controller 21 moves to step S112, and otherwise moves to step S113.

In step S112, the controller 21 determines that the edge lines indicating two sign lines are detected normally and sets the detection flag (F1) ON. After step S112, the controller 21 proceeds to step S114.

In step S113, the controller 21 determines that the edge lines indicating two sign lines are not detected normally and sets the detection flag (F1) OFF. After step S113, the controller 21 proceeds to step S114.

In step S114, the controller 21 outputs the road parameters together with the value of the detection flag (F1) to the lane keep control ECU 30. The lane keep control ECU 30 refers to the detection flag (F1). If the detection flag (F1) is ON, the lane keep control ECU 30 includes the road parameters to the object of operation, whereas if the detection flag (F1) is OFF, excludes the road parameters from the object of operation. After step S114, the controller 21 returns to step S101 of FIG. 1A.

The embodiment of the present invention is not limited to the one described above and can be modified as follows.

In the embodiment described above, the luminance data of respective pixels in the horizontal direction and the edge point detection threshold are compared at the detection of the edge point (see step S102 and FIG. 16). Alternatively, deviation of the luminance data of respective pixels in the horizontal direction from an adjacent pixel thereof may be calculated as a luminance derivative value. The magnitude (absolute values) of the derivative values of the leading edge and the trailing edge may be compared with the edge point detection threshold for the detection of the edge points (leading edge point Pu and trailing edge point Pd).

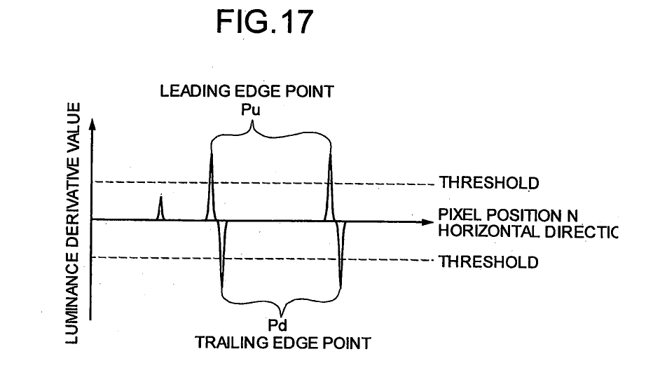

In the above embodiment, the luminance signal extracted from the video signal of the CCD camera 11 is digitized into the luminance data which is compared with the edge point detection threshold at the detection of the edge point. Alternatively, the luminance signal extracted from the video signal of the CCD camera 11 may be compared in the analog form with an analog value corresponding to the edge point detection threshold. Similarly, the luminance signal may be differentiated in analog form, and the magnitude (absolute value) of the derivative signal may be compared with an analog value corresponding to the edge point detection threshold (FIG. 17), which is similar to the one described above.

In the above embodiment, the luminance signal is extracted from the video signal of the CCD camera 11, and the sign line detection is performed with the luminance data based thereon. Alternatively, if the camera 11 is a color-type camera, hue (coloring) data may be extracted from the video signal, and the sign line detection may be performed based thereon.

In the above embodiment, the CCD camera 11 acquires the image ahead of the vehicle 1. The sign lines 5L and 5R are detected by the image recognition of the acquired image, and utilized for the lane keep control or the deviation determination. Alternatively, the CCD camera 11 may be attached to the side or the back of the vehicle 1. Then, the image on the side of or behind the vehicle 1 may be acquired. The sign lines 5L and 5R may be detected through the recognition of the acquired image to be utilized for the lane keep control or the deviation determination with respect to the lane 4. Such modification provides the same effect as the above embodiment.

In the above embodiment, the CCD camera 11 mounted on the vehicle 1 picks up the image ahead of the vehicle 1 and the sign lines 5L and 5R are detected based on the recognition of picked up image for the lane keep control or the deviation determination. Alternatively, the video may be captured by a camera arranged on the road. Based on the image recognition of such video, the sign lines 5L and 5R are detected for the lane keep control or the deviation determination with respect to the lane 4. Such modification also provides the same effect as the above embodiment. Alternatively, a navigation system mounted on the vehicle 1 may detect (acquire) a relative positional relation between the lane 4 and the vehicle 1 for the lane keep control or the deviation determination with respect to the lane 4.

In the above embodiment, the CCD camera 11 picks up the image ahead of the vehicle 1, and detects the sign lines 5L and 5R via the recognition of the picked up image for the lane keep control or the deviation determination with respect to the lane 4. Alternatively, an electromagnetic wave source, such as a magnetic marker may be arranged as a road infrastructure along the sign lines 5L and 5R. A receiver mounted on the vehicle 1 may identify the position of the electromagnetic wave source. Then, the sign lines 5L and 5R are detected based on the identified position of the electromagnetic source for the lane keep control or the deviation determination of the lane 4. Alternatively, a transmitter of the electromagnetic wave may be arranged instead of the magnetic marker. Such modification also provides the same effect as the above embodiment.

Though the CCD camera 11 is employed for image pick up in the above embodiment, other types of camera, such as an infrared camera or a complementary metal oxide semiconductor (CMOS) camera may be employed.

### INDUSTRIAL APPLICABILITY

The diagrammatizing apparatus according to the present invention can be adopted for a vehicle system which allows automatic vehicle driving and can be adopted for an automatic guided vehicle, a robot, a route bus, or an automatic warehouse, for example. The diagrammatizing apparatus can be adopted for a vehicle system which allows automatic vehicle driving through remote control via electric wave.

1. A diagrammatizing apparatus which extracts a first line and a second line which do not intersect with each other and have maximum length from an image, comprising:
a first line extracting unit that selects a longest line as the first line from a first line group consisting of a plurality of lines which intersect with each other in the image; and
a second line extracting unit that selects a longest line as the second line from a second line group consisting of a plurality of lines which intersect with each other in the image.

2. A diagrammatizing apparatus for vehicle lane detection which detects at least two lines of boundary lines of sign lines or boundary lines of a vehicle lane on a road surface from an image of the road surface, comprising:
a first boundary line extracting unit that selects a longest line as the first boundary line from a first line group consisting of a plurality of lines which intersect with each other in the image; and
a second boundary line extracting unit that selects a longest line as the second boundary line from a second line group consisting of a plurality of lines which intersect with each other in the image.

3. The diagrammatizing apparatus according to claim 1, wherein
each line is formed with a line of points, and
the length of the line is found based on a distance between two points which are located farthest from each other among a plurality of points which constitute the line of points.

4. The diagrammatizing apparatus according to claim 1, wherein
each line is formed with a line of points, and
the length of the line is found based on a number of points which constitute the line of points.

5. The diagrammatizing apparatus according to claim 1, wherein
each line is formed with a line of points, and
the length of the line is found based on a function of a distance between two points which are located farthest from each other among a plurality of points which constitute the line of points and a number of points which constitute the line of points.

6. The diagrammatizing apparatus according to claim 3, wherein
the line which is formed with the line of points is extracted from the points in the image via Hough transform.

7. The diagrammatizing apparatus according to claim 6, wherein
each of the first line group and the second line group is detected as a result of determination on whether the plurality of lines intersect with each other or not with a use of a parameter space of the Hough transform.

8. The diagrammatizing apparatus according to claim 6, wherein
selection of the longest line from the first line group and selection of the longest line from the second line group are performed with at least one of a vote value cast in a parameter space of the Hough transform, and a coordinate value corresponding to points to which a vote is cast in the parameter space.

9. The diagrammatizing apparatus according to claim 2, wherein
each line is formed with a line of points, and
the length of the line is found based on a distance between two points which are located farthest from each other among a plurality of points which constitute the line of points.

10. The diagrammatizing apparatus according to claim 9, wherein
the line which is formed with the line of points is extracted from the points in the image via Hough transform.

11. The diagrammatizing apparatus according to claim 10, wherein
each of the first line group and the second line group is detected as a result of determination on whether the plurality of lines intersect with each other or not with a use of a parameter space of the Hough transform.

12. The diagrammatizing apparatus according to claim 10, wherein
selection of the longest line from the first line group and selection of the longest line from the second line group are performed with at least one of a vote value cast in a parameter space of the Hough transform, and a coordinate value corresponding to points to which a vote is cast in the parameter space.

13. The diagrammatizing apparatus according to claim 2, wherein
each line is formed with a line of points, and
the length of the line is found based on a number of points which constitute the line of points.

14. The diagrammatizing apparatus according to claim 13, wherein
the line which is formed with the line of points is extracted from the points in the image via Hough transform.

15. The diagrammatizing apparatus according to claim 14, wherein
each of the first line group and the second line group is detected as a result of determination on whether the plurality of lines intersect with each other or not with a use of a parameter space of the Hough transform.

16. The diagrammatizing apparatus according to claim 14, wherein
selection of the longest line from the first line group and selection of the longest line from the second line group are performed with at least one of a vote value cast in a parameter space of the Hough transform, and a coordinate value corresponding to points to which a vote is cast in the parameter space.

17. The diagrammatizing apparatus according to claim 2, wherein
each line is formed with a line of points, and
the length of the line is found based on a function of a distance between two points which are located farthest from each other among a plurality of points which constitute the line of points and a number of points which constitute the line of points.

18. The diagrammatizing apparatus according to claim 17, wherein
the line which is formed with the line of points is extracted from the points in the image via Hough transform.

19. The diagrammatizing apparatus according to claim 17, wherein
each of the first line group and the second line group is detected as a result of determination on whether the plurality of lines intersect with each other or not with a use of a parameter space of the Hough transform.

20. The diagrammatizing apparatus according to claim 19, wherein
selection of the longest line from the first line group and selection of the longest line from the second line group are performed with at least one of a vote value cast in a parameter space of the Hough transform, and a coordinate value corresponding to points to which a vote is cast in the parameter space.

21. The diagrammatizing apparatus according to claim 4, wherein
the line which is formed with the line of points is extracted from the points in the image via Hough transform.

22. The diagrammatizing apparatus according to claim 21, wherein
each of the first line group and the second line group is detected as a result of determination on whether the plurality of lines intersect with each other or not with a use of a parameter space of the Hough transform.

23. The diagrammatizing apparatus according to claim 21, wherein
selection of the longest line from the first line group and selection of the longest line from the second line group are performed with at least one of a vote value cast in a parameter space of the Hough transform, and a coordinate value corresponding to points to which a vote is cast in the parameter space.

24. The diagrammatizing apparatus according to claim 5, wherein
the line which is formed with the line of points is extracted from the points in the image via Hough transform.

25. The diagrammatizing apparatus according to claim 24, wherein
each of the first line group and the second line group is detected as a result of determination on whether the plurality of lines intersect with each other or not with a use of a parameter space of the Hough transform.

26. The diagrammatizing apparatus according to claim 24, wherein
selection of the longest line from the first line group and selection of the longest line from the second line group are performed with at least one of a vote value cast in a parameter space of the Hough transform, and a coordinate value corresponding to points to which a vote is cast in the parameter space.
